(19) United States
(12) Patent Application Publication
(10) Pub. No.: US 2015/0347001 A1
(43) Pub. Date: Dec. 3, 2015

(54) ELECTRONIC DEVICE, METHOD AND STORAGE MEDIUM

(71) Applicant: Kabushiki Kaisha Toshiba, Tokyo (JP)

(72) Inventor: Shigeru Motoi, Kokubunji Tokyo (JP)

(21) Appl. No.: 14/823,236

(22) Filed: Aug. 11, 2015

Related U.S. Application Data
(63) Continuation of application No. PCT/JP2013/065281, filed on May 31, 2013.

(51) Int. Cl. G06F 3/0488; G06K 9/00; G06F 3/041; G06K 9/22

(52) U.S. Cl. CPC G06F 3/04883; G06K 9/222; G06K 9/00402; G06F 3/041

(57) ABSTRACT

According to one embodiment, a method includes receiving stroke data corresponding to a first stroke handwritten on a display, and displaying, on the display, the first stroke corresponding to the stroke data and a second stroke following the first stroke, the second stroke comprising a variable length depending on a handwriting direction of the first stroke.

### CROSS REFERENCE TO RELATED APPLICATIONS

This application is a Continuation Application of PCT Application No. PCT/JP2013/065281, filed May 31, 2013, the entire contents of which are incorporated herein by reference.

### FIELD

Embodiments described herein relate generally to display of handwritten documents of handwritten characters, symbols, drawings and the like.

### BACKGROUND

In recent years, various types of electronic devices such as tablets, personal digital assistants (PDAs) and smart phones have been developed. Most of these devices include a touch screen display to allow the user to easily perform an input operation.

The user touches a menu or an object displayed on the touch screen display with fingers, etc. Thus, the user can instruct the electronic device to execute a function associated with the menu or the object.

Input operations using the touch screen display are not only used to provide the electronic device with operation instructions but also used to input data in documents in handwriting. Recently, some people attend a meeting, etc., with this type of electronic device and take notes through handwriting input on the touch screen display. Various suggestions have been made regarding the operations related to handwriting input.

A delay of approximately several tens of milliseconds to a hundred milliseconds is caused from when a character or drawing is input on the touch screen display with a stylus or a finger to when the character or drawing is actually displayed on the touch screen display through a process of the input data (in other words, the coordinate data of points constituting strokes) by software including an operating system (OS) and preparation of strokes connecting the coordinates. This delay makes the user uncomfortable with handwriting input on the touch screen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of the external appearance of an electronic device according to an embodiment.

FIG. 2 is a block diagram showing an example of cooperation between the electronic device and other devices.

FIG. 3 shows an example of a document handwritten on a touch screen display.

FIG. 4 shows an example of handwritten document data which is a series of stroke data items.

FIG. 5 is a block diagram showing an example of a system configuration of the electronic device.

FIG. 6 exemplarily shows a home screen displayed by the electronic device.

FIG. 7 exemplarily shows a notebook preview screen displayed by the electronic device.

FIG. 8 exemplarily shows a setting screen displayed by the electronic device.

FIG. 9 exemplarily shows a page edit screen displayed by the electronic device.

FIG. 10 exemplarily shows a search dialogue displayed by the electronic device.

FIG. 11 is an exemplary block diagram showing a function configuration according to a digital notebook application program executed by the electronic device.

FIG. 12 shows an example of delay of display of the path (stroke) of handwriting input.

FIG. 13A exemplarily shows an effect which is caused when the prediction is wrong in handwriting input with a right hand.

FIG. 13B exemplarily shows an effect which is caused when the prediction is wrong in handwriting input with a right hand.

FIG. 14A exemplarily shows an effect which is caused when the prediction is wrong in handwriting input with a left hand.

FIG. 14B exemplarily shows an effect which is caused when the prediction is wrong in handwriting input with a left hand.

FIG. 15A shows an example of change of setting of the prediction length or prediction time in accordance with the dominant hand and the writing direction.

FIG. 15B shows an example of change of setting of the prediction length or prediction time in accordance with the dominant hand and the writing direction.

FIG. 16 is a flowchart showing an example of a determination process of the dominant hand in handwriting input.

FIG. 17A shows an example of a case where a stylus is held with inclination such that the stylus point is toward the user.

FIG. 17B shows an example of a case where a stylus is held with inclination such that the stylus point is toward the user.

FIG. 18A shows an example of stroke display.

FIG. 18B shows an example of stroke display.

FIG. 19 is a flowchart showing an example of the flow of the display process of FIG. 18.

FIG. 20 explains an example of how to obtain the writing direction of FIGS. 18A and 18B.

FIG. 21A shows another example of stroke display.

FIG. 21B shows another example of stroke display.

### DETAILED DESCRIPTION

Various embodiments will be described hereinafter with reference to the accompanying drawings.

In general, according to one embodiment, a method includes receiving stroke data corresponding to a first stroke handwritten on a display, and displaying, on the display, the first stroke corresponding to the stroke data and a second stroke following the first stroke, the second stroke comprising a variable length depending on a handwriting direction of the first stroke.

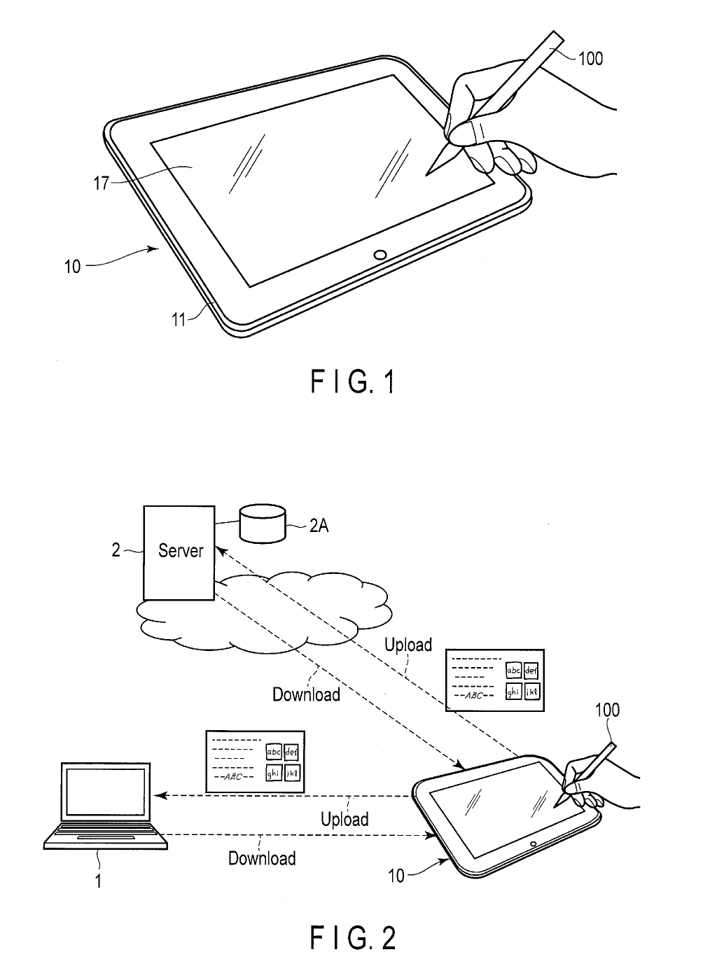

FIG. 1 is a perspective view showing an example of the external appearance of an electronic apparatus according to an embodiment. The electronic device is, for example, a stylus-based portable electronic device which enables handwriting input with a stylus or a finger. The electronic device may be realized as, for example, a tablet computer, a notebook personal computer, a smart phone or a PDA. Hereinafter, for example, the electronic device is realized as a tablet computer 10. The tablet computer 10 is a portable electronic device which is also called a tablet or a slate computer. A main body 11 includes a housing having a thin-box shape.

A touch screen display 17 is attached to the main body so as to overlap the upper surface thereof. A flat-panel display and a sensor are incorporated into the touch screen display 17. The sensor is configured to detect the contact position of a stylus or a finger on the screen of the flat-panel display. The flat-panel display may be, for example, a liquid crystal display (LCD). For the sensor, for example, a capacitive touch panel or an electromagnetic induction type of digitizer may be used. In the description below, both of the two sensors, which are a digitizer and a touch panel, are incorporated into the touch screen display 17. The touch screen display 17 is configured to detect a touch operation with a finger relative to the screen as well as a touch operation with a stylus 100 relative to the screen.

The stylus 100 may be, for example, a digitizer stylus (electromagnetic induction type of stylus). The user can perform a handwriting input operation on the touch screen display 17, using the stylus 100 (a stylus input mode). In the stylus input mode, the path of movement of the stylus 100 on the screen is obtained. In other words, strokes made by a handwriting input operation are obtained. In this manner, a series of strokes input in handwriting are displayed on the screen. The path of movement of the stylus 100 in a contact period of the stylus 100 on the screen is equivalent to one stroke. A series of strokes constitute a character, a symbol, etc. The series of many strokes corresponding to, for example, handwritten characters, handwritten drawings and handwritten tables constitutes a handwritten document.

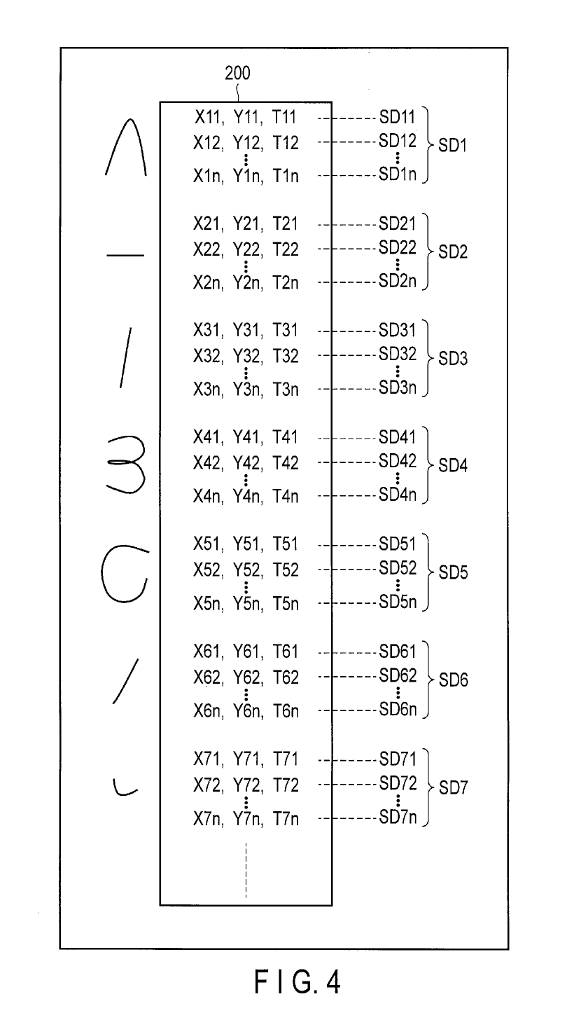

In the embodiment, the handwritten document is not stored as image data. Instead, the handwritten document is stored in a storage medium as time-series data called handwritten document data indicative of a series of the coordinates of the path of each stroke and the order relationships of strokes. The detail of handwritten document data is explained later with reference to FIG. 4. Briefly speaking, the handwritten document data indicates the order in which strokes are handwritten, and includes stroke data items corresponding to the strokes, respectively. In other words, the handwritten document data refers to time-series stroke data items corresponding to strokes, respectively. Each stroke data item corresponds to a stroke and includes a series of coordinate data items (time-series coordinates) each corresponding to a point on the path of the stroke. The order in which the stroke data items are arranged is equivalent to the order in which the strokes are handwritten.

The tablet computer 10 is configured to read an arbitrary existing handwritten document data item from a storage medium and display a handwritten document corresponding to the handwritten document data on the screen. In other words, the tablet computer 10 is configured to display strokes indicated by the handwritten document data items on the screen. The strokes indicated by the handwritten document data items are also strokes input in handwriting.

Further, the tablet computer 10 of the present embodiment has a touch input mode for performing a handwriting input operation with a finger without using the stylus 100. When the touch input mode is effective, the user can perform a handwriting input operation on the touch screen display 17, using a finger. In the touch input mode, the path of movement of a finger on the screen is obtained. In other words, strokes made by a handwriting input operation are obtained. In this manner, strokes input in handwriting are displayed on the screen.

The tablet computer 10 may have an edit function. The edit function allows the user to delete or move an arbitrary handwritten portion (an arbitrary handwritten character, mark, drawing, table, etc.) selected by a range selection tool in the handwritten document displayed in progress in accordance with a user's edit operation using an eraser tool, the range selection tool and other various tools. Moreover, an arbitrary handwritten portion selected by the range selection tool in a handwritten document can be specified as a search key for searching for the handwritten document. Further, a recognition process such as a handwritten character recognition, a handwritten drawing recognition or a handwritten table recognition can be executed for an arbitrary handwritten portion selected by the range selection tool in a handwritten document.

In the present embodiment, a handwritten document may be managed as one page or a plurality of pages. In this case, handwritten document data items may be grouped for each area fit within one screen. A group of handwritten document data items fit within one screen may be stored as one page. The size of a page may be changeable. In this case, a page can be expanded so as to be larger than one screen. Therefore, a handwritten document larger than the screen can be dealt with as one page. When the whole part of one page cannot be simultaneously displayed on the display, the page may be scaled down, or the display target section of the page may be moved by vertical or lateral scrolling.

FIG. 2 shows an example of cooperation between the tablet computer 10 and external devices. The tablet computer 10 may include a wireless communication device such as a wireless LAN and is configured to wirelessly communicate with a personal computer 1. The tablet computer 10 is further configured to communicate with a server 2 on an Internet 3, using the wireless communication device. The server 2 may be a server which executes an online storage service and other various cloud computing services.

The personal computer 1 may include a storage device such as a hard disk drive (HDD). The tablet computer 10 is configured to transmit handwritten document data to the personal computer 1 and store the data in the HDD of the personal computer 1. This process may be referred to as upload. The personal computer 1 may authenticate the tablet computer 10 at the start of communication to obtain secure communication between the tablet computer 10 and the personal computer 1. In this case, a dialogue for prompting the user to input an ID or a password may be displayed on the screen of the tablet computer 10, or the ID of the tablet computer 10 may be automatically transmitted from the tablet computer 10 to the personal computer 1.

In this manner, even when the capacity of the storage of the tablet computer 10 is small, the tablet computer 10 is capable of dealing with a large number of handwritten document data items or a large volume of handwritten document data items.

The tablet computer 10 may be configured to read (download) one or more arbitrary handwritten document data items stored in the HDD of the personal computer 1 and display the strokes indicated by the read handwritten document data items on the screen of the display 17 of the tablet computer 10. In this case, a list of thumbnails obtained by scaling down the pages of the handwritten document data items may be displayed on the screen of the display 17, or one page selected from the thumbnails may be displayed with the normal size on the screen of the display 17.

As described above, the other party with which the tablet computer 10 communicates may not be the personal computer 1 and may be the server 2 on the cloud system which provides a storage service, etc. The tablet computer 10 is configured to transmit handwritten document data to the server 2 via the Internet and store the data in a storage device 2A of the server 2. This process may be referred to as upload. The tablet computer 10 may be configured to read (download) arbitrary handwritten document data stored in the storage device 2A of the server 2 and display the path of each of the strokes indicated by the handwritten document data on the screen of the display 17 of the tablet computer 10.

In this manner, in the present embodiment, the storage medium in which handwritten document data is stored may be any one of the storage device of the tablet computer 10, the storage device of the personal computer 1 and the storage device of the server 2.

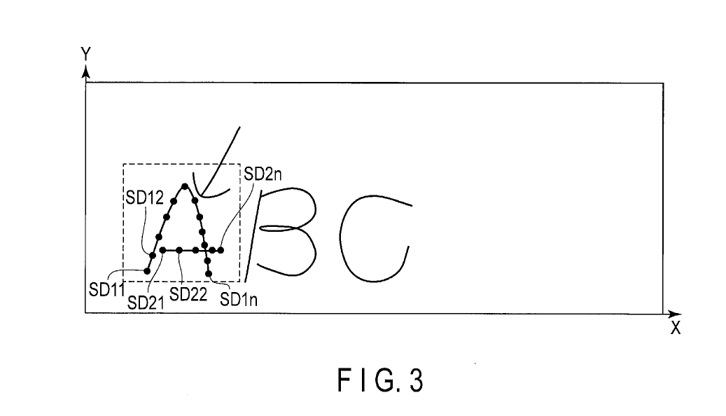

Now, the relationship between strokes (characters, drawings, tables, etc.) made by the user and handwritten document data will be descried referring to FIG. 3 and FIG. 4. FIG. 3 shows an example of a document (character string) handwritten on the touch screen display 17 using the stylus 100, etc.

A character or drawing is handwritten in a document, and another character or drawing may be handwritten on the character or drawing which has been already written. In FIG. 3, the characters “A”, “B” and “C” are input in handwriting in this order, and subsequently, an arrow is input in handwriting in vicinity to the handwritten character “A”.

The handwritten character “A” is shown by two strokes (the stroke having the shape of “Λ” and the stroke having the shape of “−”) made by using the stylus 100, in short, shown by two paths. For example, the first path of the stylus 100 with the shape of “A” is sampled in real time at equal time intervals or equal spatial intervals. Through this process, the time-series coordinates (SD11, SD12, . . . , SD1n) of the stroke having the shape of “Λ” can be obtained. The subsequent path of the stylus 100 with the shape of “−” is also sampled in real time at equal time intervals. Through this process, the time-series coordinates (SD21, SD22, . . . , SD2n) of the stroke having the shape of “−” can be obtained.

The handwritten character “B” is shown by two strokes made by using the stylus 100, etc., in short, shown by two paths. The handwritten character “C” is shown by one stroke made by using the stylus 100, etc., in short, shown by one path. The handwritten arrow is shown by two strokes made by using the stylus 100, etc., in short, shown by two paths.

FIG. 4 shows handwritten document data 200 corresponding to the handwritten document shown in FIG. 3. The handwritten document data includes seven stroke data items SD1, SD2, . . . , SD7. In the handwritten document data 200, the stroke data items SD1, SD2, . . . , SD7 are arranged in the chronological order in which the strokes are made.

In the handwritten document data 200, the first two stroke data items SD1 and SD2 indicate the two strokes of the handwritten character “A”, respectively. The third and fourth stroke data items SD3 and SD4 indicate the two strokes constituting the handwritten character “B”, respectively. The fifth stroke data item SD5 indicates the stroke constituting the handwritten character “C”. The sixth and seventh stroke data items SD6 and SD7 indicate the two strokes constituting the handwritten arrow, respectively.

Each stroke data item includes a series of coordinate data items (time-series coordinates) corresponding to one stroke. In other words, each stroke data item includes a plurality of coordinates corresponding to a plurality of sample points on the path of one stroke, respectively. In each stroke data item, the coordinates of a plurality of sample points are arranged in the chronological order in which the stroke is made (sampled). For example, with regard to the handwritten character “A”, stroke data item SD1 includes a series of coordinate data items (time-series coordinates) each corresponding to a point on the path of the stroke having the shape of “Λ” of the handwritten character “A”. In other words, stroke data item SD1 includes n coordinate data items SD11, SD12, . . . , SD1n. Stroke data item SD2 includes a series of coordinate data items each corresponding to a point on the path of the stroke having the shape of “−” of the handwritten character “A”. In other words, stroke data item SD2 includes n coordinate data items SD21, SD22, . . . , SD2n. The number of coordinate data items may differ depending on the stroke data item. When strokes are sampled at equal time intervals, the number of sample points differs since the strokes have different lengths from each other.

Each coordinate data item indicates the X- and Y-coordinates of a point on the corresponding path. For example, coordinate data item SD11 indicates the X-coordinate (X11) and the Y-coordinate (Y11) of the starting point of the stroke having the shape of “Λ”. SD1n indicates the X-coordinate (X1n) and the Y-coordinate (Y1n) of the end point of the stroke having the shape of “Λ”.

Each coordinate data item may include time stamp data T corresponding to the time (sample time) when the point corresponding to the coordinates is handwritten. The time when the point is handwritten may be an absolute time (for example, year/month/day/hour/minute/second) or a relative time based on a time. For example, the absolute time (for example, year/month/day/hour/minute/second) when the user starts writing a stroke may be added as time stamp data to the corresponding stroke data item. The relative time indicating the difference from the absolute time may be added as time stamp data T to each coordinate data item of the stroke data item.

It is possible to further accurately show the temporal relationships between strokes by using handwritten document data in which time stamp data T is added to each coordinate data item. Data Z indicating the writing pressure may be added to each coordinate data item (not shown in FIG. 4).

The handwritten document data 200 having the structure explained in FIG. 4 is configured to show the temporal relationships between strokes as well as the path of each stroke. The use of the handwritten document data 200 allows the handwritten character “A” to be dealt with a character or drawing different from the apical end portion of the handwritten arrow even when the apical end portion of the handwritten arrow overlaps or is close to the handwritten character “A” as shown in FIG. 3.

In the present embodiment, as described above, handwritten document data is not stored as an image or a character recognition result. Instead, handwritten document data is stored as the handwritten document data 200 structured by a series of time-series stroke data items. Therefore, handwritten characters can be dealt with without relying on the language of the characters. Thus, the structure of the handwritten document data 200 of the present embodiment can be used in common with various countries using different languages in the world.

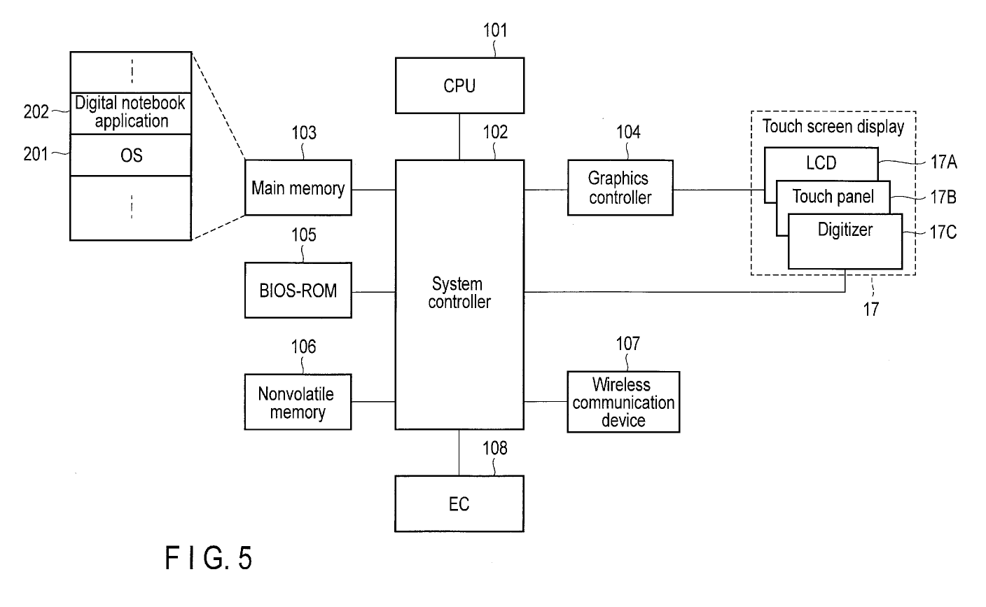

FIG. 5 shows a system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor configured to control the operations of various modules of the tablet computer 10. The CPU 101 executes various types of software loaded from the nonvolatile memory 106 which is a semiconductor storage device to the main memory 103. The software includes an operating system (OS) 201 and various application programs. The application programs include a digital notebook application program 202. Hereinafter, handwritten document data is also referred to as a handwritten notebook. The digital notebook application program 202 has a function of creating and displaying the above handwritten document data, a function of editing handwritten document data, and a handwritten document search function for searching for handwritten document data containing a desired handwritten portion or a desired handwritten portion in handwritten document data.

The CPU 101 executes a Basic Input/Output System (BIOS) stored in the BIOS-ROM 105. The BIOS is a program for hardware control.

The system controller 102 is a device configured to connect a local bus of the CPU 101 and various components and modules. The system controller 102 includes a built-in memory controller configured to control the access to the main memory 103. The system controller 102 has a function of communicating with the graphics controller 104 through a serial bus conforming to the PCI EXPRESS standard, etc.

The graphics controller 104 is a display controller configured to control an LCD 17A used as a display monitor of the tablet computer 10. A display signal generated by the graphics controller 104 is transmitted to the LCD 17A. The LCD 17A displays a screen image based on the display signal. A touch panel 17B, the LCD 17A and a digitizer 17C overlap each other. The touch panel 17B is a capacitive pointing device for inputting data on the screen of the LCD 17A. The touch panel 17B detects the contact position of a finger on the screen, the movement of the contact position, etc. The digitizer 17C is an electromagnetic induction type of pointing device for inputting data on the screen of the LCD 17A. The digitizer 17C detects the contact position of the stylus (digitizer stylus) 100 on the screen, the movement of the contact position, etc.

The wireless communication device 107 is a device configured to perform wireless communication using, for example, a wireless LAN or 3G mobile communications. The EC 108 is a single-chip microcomputer including an embedded controller for power management. The EC 108 has a function of switching the tablet computer 10 on or off in response to the operation of a power button by the user.

Now, this specification explains some typical examples of screens shown by the digital notebook application program 202 to the user.

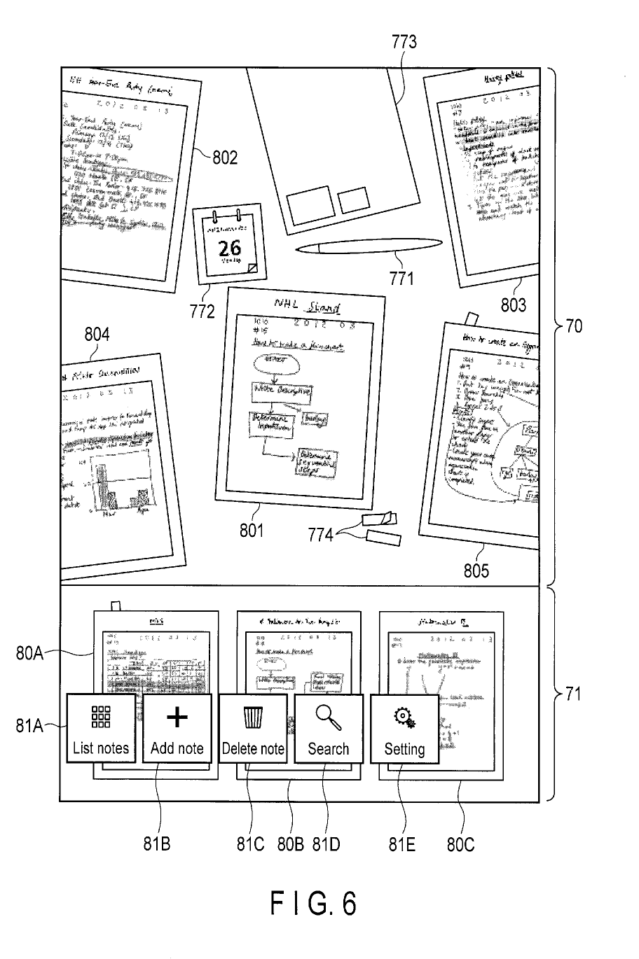

FIG. 6 shows an example of a home screen of the digital notebook application program 202. The home screen is a basic screen for dealing with a plurality of handwritten document data items and is configured to manage notebooks and set the application as a whole.

The home screen includes a desktop screen area 70 and a drawer screen area 71. The desktop screen area 70 is a temporary area configured to display a plurality of notebook icons 801 to 805 corresponding to a plurality of handwritten notebooks the user is working on. Each of the notebook icons 801 to 805 displays the thumbnail of a page of the corresponding handwritten notebook. The desktop screen area 70 further displays a pen icon 771, a calendar icon 772, a scrap notebook (gallery) icon 773 and a tag (label) icon 774.

The pen icon 771 is a graphical user interface (GUI) element for switching the display screen from the home screen to a page edit screen. The calendar icon 772 is an icon showing the current date. The scrap notebook icon 773 is a GUI element for viewing data loaded from other application programs or other files (hereinafter, referred to as scrap data or gallery data). The tag icon 774 is a GUI element for attaching a label (tag) to an arbitrary page in an arbitrary handwritten notebook.

The drawer screen area 71 is a display area for viewing a storage area for storing all of the created handwritten notebooks. The drawer screen area 71 displays notebook icons 80A, 80B and 80C corresponding to some handwritten notebooks of all handwritten notebooks. Each of the notebook icons 80A, 80B and 80C displays the thumbnail of a page of the corresponding handwritten notebook. The digital notebook application program 202 is configured to detect a gesture (for example, a swipe gesture) performed by the user with the stylus 100 or a finger on the drawer screen area 71. The digital notebook application program 202 allows the user to scroll the screen image on the drawer screen area 71 to the left or right in response to the detection of the gesture (for example, a swipe gesture). In this way, it is possible to display notebook icons corresponding to arbitrary handwritten notebooks, respectively, in the drawer screen area 71.

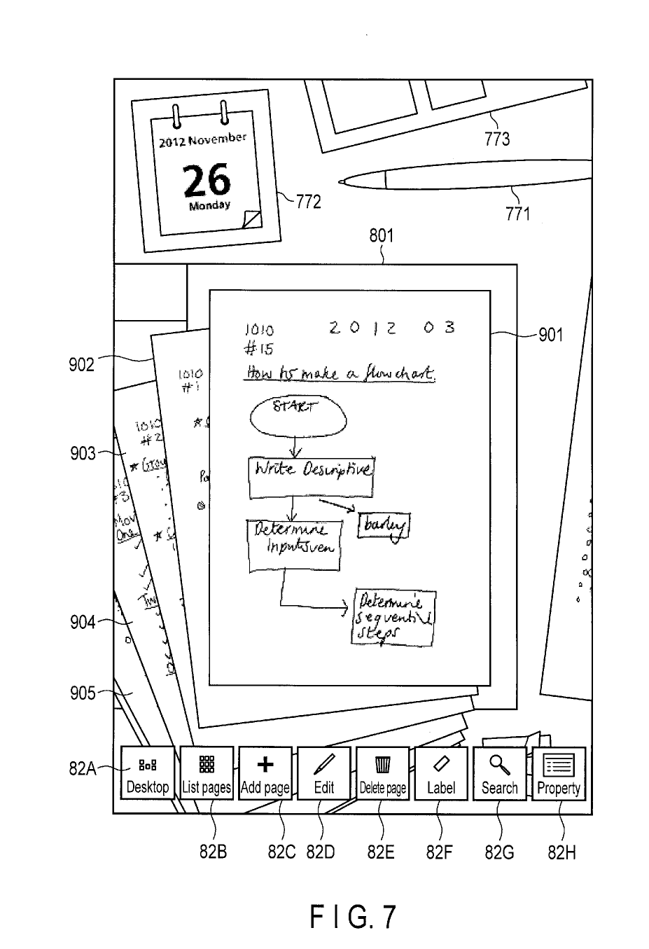

The digital notebook application program 202 is configured to detect a gesture (for example, a tap gesture) performed by the user with the stylus 100 or a finger on the notebook icons in the drawer screen area 71. In response to the detection of a gesture (for example, a tap gesture) on a notebook icon in the drawer screen area 71, the digital notebook application program 202 moves the notebook icon to the middle portion of the desktop screen area 70. The digital notebook application program 202 selects a handwritten notebook corresponding to the notebook icon and displays the notebook preview screen shown in FIG. 7 instead of the desktop screen. The notebook preview screen shown in FIG. 7 is a screen which allows the user to view an arbitrary page in the selected handwritten notebook.

The digital notebook application program 202 is further configured to detect a gesture (for example, a tap gesture) performed by the user with the stylus 100 or a finger in the desktop screen area 70. In response to the detection of a gesture (for example, a tap gesture) on the notebook icon located in the middle portion of the desktop screen area 70, the digital notebook application program 202 selects a handwritten notebook corresponding to the notebook icon located in the middle portion and displays the notebook preview screen shown in FIG. 7 instead of the desktop screen.

The home screen is further configured to display a menu. This menu includes a notebook list button 81A, a new notebook addition button 81B, a notebook deletion button 81C, a search button 81D and a setting button 81E displayed in the lower part of the screen, for example, the drawer screen area 71. The notebook list button 81A is a button for displaying a list of handwritten notebooks. The new notebook addition button 81B is a button for opening (adding) a new handwritten notebook. The notebook deletion button 81C is a button for deleting a handwritten notebook. The search button 81D is a button for opening a search screen (search dialogue). The setting button 81E is a button for opening the setting screen of the application.

A return button, a home button and a recent application button are also displayed under the drawer screen area 71 (not shown).

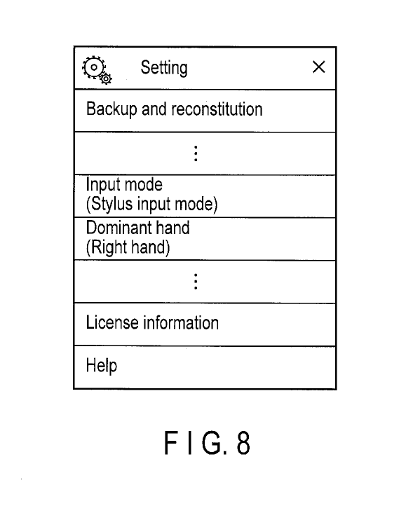

FIG. 8 shows an example of a setting screen which opens when the setting button 81E is tapped with the stylus 100 or a finger.

This setting screen displays various setting items. The setting items may include “backup and reconstitution”, “input mode (a stylus or touch input mode)”, “dominant hand (right hand or left hand)”, “license information” and “help”. When the button corresponding to the setting item “dominant hand” is tapped by the stylus 100 or a finger, a screen for selecting the right hand dominance or left hand dominance is displayed.

When the notebook addition button 81B is tapped by the stylus 100 or a finger on the home screen, a notebook addition screen is displayed. Here, the notebook title is input to the title column in handwriting. The front cover and paper of the notebook can be selected. When the addition button 81B is pressed, a new notebook is opened. The new notebook is placed in the drawer screen area 71.

FIG. 7 shows an example of the aforementioned notebook preview screen.

The notebook preview screen is a screen which enables the user to view an arbitrary page in the selected handwritten notebook. It is assumed that a handwritten notebook corresponding to the notebook icon 801 in the desktop screen area 70 on the home screen is selected. In this case, the digital notebook application program 202 displays a plurality of pages 901, 902, 903, 904 and 905 included in the handwritten notebook such that at least a part of each of the pages 901, 902, 903, 904 and 905 is visible and the pages 901, 902, 903, 904 and 905 overlap each other.

The notebook preview screen further displays the pen icon 771, the calendar icon 772, the scrap notebook icon 773 and the tag icon 774.

The notebook preview screen is further configured to display a menu in the lower part of the screen. This menu includes a home button 82A, a page list button 82B, a page addition button 82C, a page edit button 82D, a page deletion button 82E, a label button 82F, a search button 82G and a property display button 82H. The home button 82A is a button for closing the preview of the notebook and displaying the home screen. The page list button 82B is a button for displaying a list of pages in the handwritten notebook which is currently selected. The page addition button 82C is a button for opening (adding) a new page. The edit button 82D is a button for displaying a page edit screen. The page deletion button 82E is a button for deleting a page. The label button 82F is a button for displaying a list of available label types. The search button 82G is a button for displaying a search screen. The property display button 82H is a button for displaying the property of the notebook.

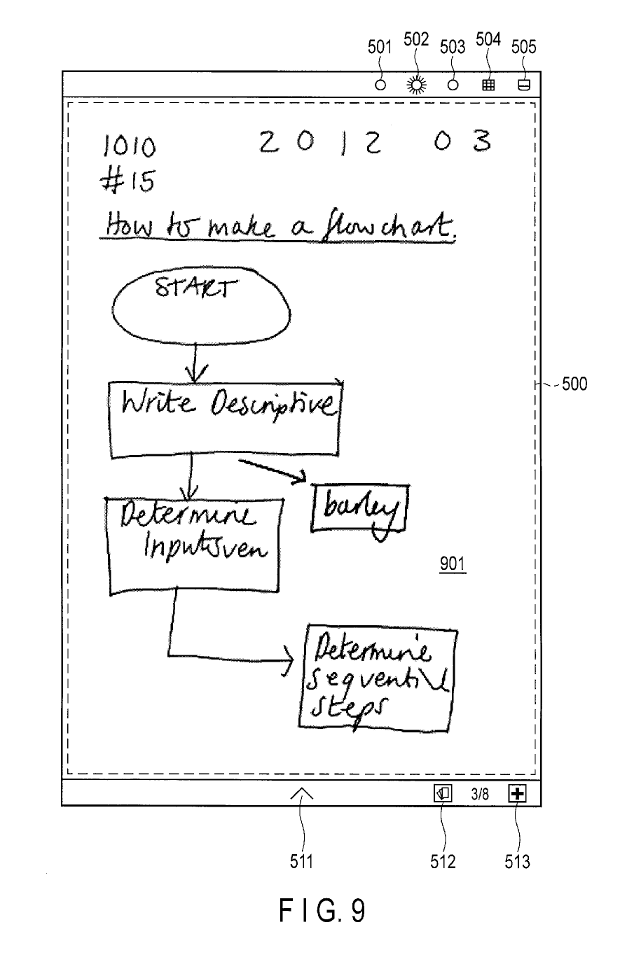

The digital notebook application program 202 is configured to detect various gestures performed by the user on the notebook preview screen. For example, in response to the detection of a gesture, the digital notebook application program 202 changes the page to be displayed on the top to an arbitrary page (page advance or page return). The digital notebook application program 202 selects the top page and displays the page edit screen shown in FIG. 9 instead of the notebook preview screen in response to the detection of a gesture (for example, a tap gesture) performed on the top page, the detection of a gesture (for example, a tap gesture) performed on the pen icon 771, or the detection of a gesture (for example, a tap gesture) performed on the edit button 82D.

The page edit screen shown in FIG. 9 is a screen which allows the user to prepare a new page (handwritten page) and view and edit an existing page. When the page 901 on the notebook preview screen shown in FIG. 7 is selected, as shown in FIG. 9, the page edit screen displays the content of page 901.

On the page edit screen, a rectangular area 500 surrounded by broken lines is a handwriting input area which allows handwriting. In the handwriting input area 500, an input even from the digitizer 17C is used to display (draw) handwritten strokes and is not used as an event showing a gesture such as a tap gesture. On the other hand, in the areas other than the handwriting input area 500 on the page edit screen, an input event from the digitizer 17C may be also used as an event showing a gesture such as a tap gesture.

An input event from the touch panel 17B is not used to display (draw) handwritten strokes and is used as an event showing a gesture such as a tap gesture or a swipe gesture.

The page edit screen further displays a quick select menu including three types of pens 501 to 503 registered by the user in advance, a range selection pen 504 and an eraser pen 505 in the upper part of the screen outside the handwriting input area 500. Here, a black pen 501, a red pen 502 and a marker 503 are registered by the user in advance. The user can switch the pen type to be used by tapping a pen (button) in the quick select menu with the stylus 100 or a finger. For example, the digital notebook application program 202 displays black strokes (paths) on the page edit screen in accordance with the movement of the stylus 100 when a handwriting input operation is performed on the page edit screen with the stylus 100 in a state where the black pen 501 is selected by a user's tap gesture with the stylus 100 or a finger.

The three types of pens in the quick select menu can be switched by an operation of a side button (not shown) of the stylus 100. A combination of a pen color and a pen thickness which are frequently used can be set for each of the three types of pens in the quick select menu.

The page edit screen further displays a menu button 511, a page return button 512 (for returning to the notebook preview screen) and a new page addition button 513 in the lower part of the screen outside the handwriting input area 500. The menu button 511 is a button for displaying a menu.

For example, this menu may display buttons for putting the page into a trash, attaching a part of the copied or cut page, opening a search screen, displaying an export sub-menu, displaying an import sub-menu, sending e-mail by converting the page into text, and displaying a pen case. For example, the export sub-menu allows the user to select a function of recognizing the handwritten page displayed on the page edit screen and converting the page into an electronic document file, a presentation file, an image file, etc., or a function of converting the page into an image file and sharing the file with other applications. For example, the import sub-menu allows the user to select a function of importing a memo from a memo gallery or a function of importing an image from a gallery. The pen case is a button for invoking a pen setting screen which allows the user to change the color (the color of line to be drawn) and the thickness (the thickness of line to be drawn) of each of the three types of pens in the quick select menu.

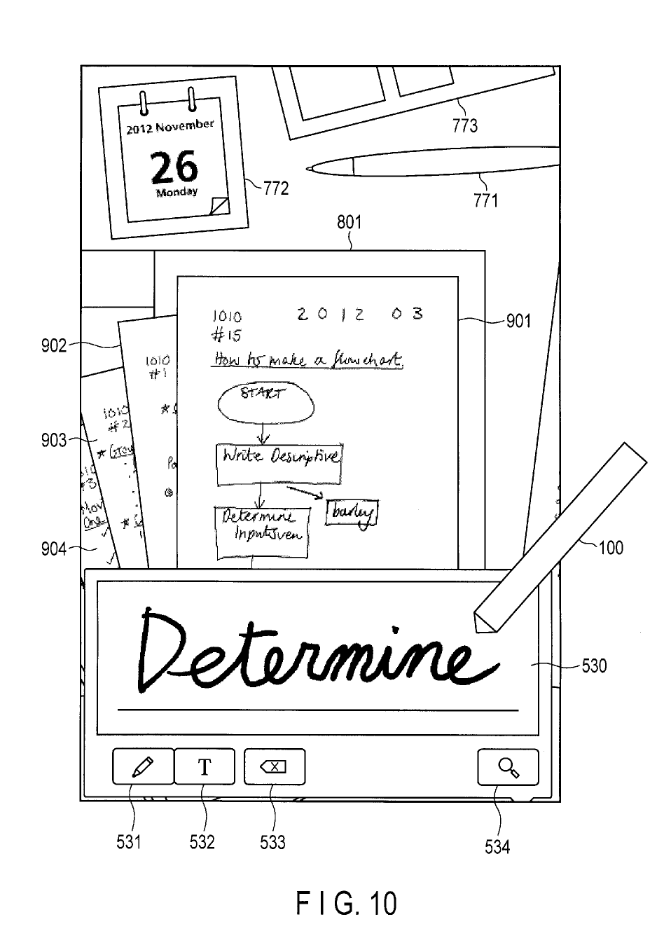

FIG. 10 shows an example of a search screen (search dialogue). FIG. 10 shows a case where a search screen (search dialogue) is opened on the notebook preview screen.

The search screen displays a search key input area 530, a stroke search button 531, a text search button 532, a delete button 533 and a search execution button 534. The stroke search button 531 is a button for selecting a stroke search. The text search button 532 is a button for selecting a text search. The search execution button 534 is a button for requesting execution of a search process.

In the stroke search, the search key input area 530 is used as an input area for handwriting a character string, a drawing or a table to be a search key. In FIG. 10, a handwritten character string “Determine” is input as a search key in the search key input area 530. The user can handwrite a drawing and a table as well as a character string in the search key input area 530 with the stylus 100. When the user selects the search execution button 534 in a state where the handwritten character string “Determine” is input as a search key in the search key input area 530, the stroke group (query stroke group) of the handwritten character string “Determine” is used to execute a stroke search for searching for a handwritten notebook containing a stroke group corresponding to the query stroke group. In the stroke search, a stroke group similar to the query stroke group is searched for by a match process between strokes. To calculate the similarity between the query stroke group and another stroke group, dynamic programming (DP) matching may be used.

In a text search, for example, a software keyboard is displayed on the screen. The user can input arbitrary text (an arbitrary character string) in the search key input area 530 as a search key by operating the software keyboard. When the user selects the search execution button 534 in a state where text is input as a search key in the search key input area 530, a text search for searching for a handwritten notebook containing a stroke data group corresponding to the text (query text) is executed.

A stroke search/text search may be executed for all handwritten notebooks or only the selected handwritten notebook. When a stroke search/text search is executed, a search result screen is displayed. The search result screen displays a list of handwritten pages containing a stroke group corresponding to a query stroke group (or query text). A hit word (a stroke group corresponding to a query stroke group or query text) is highlighted.

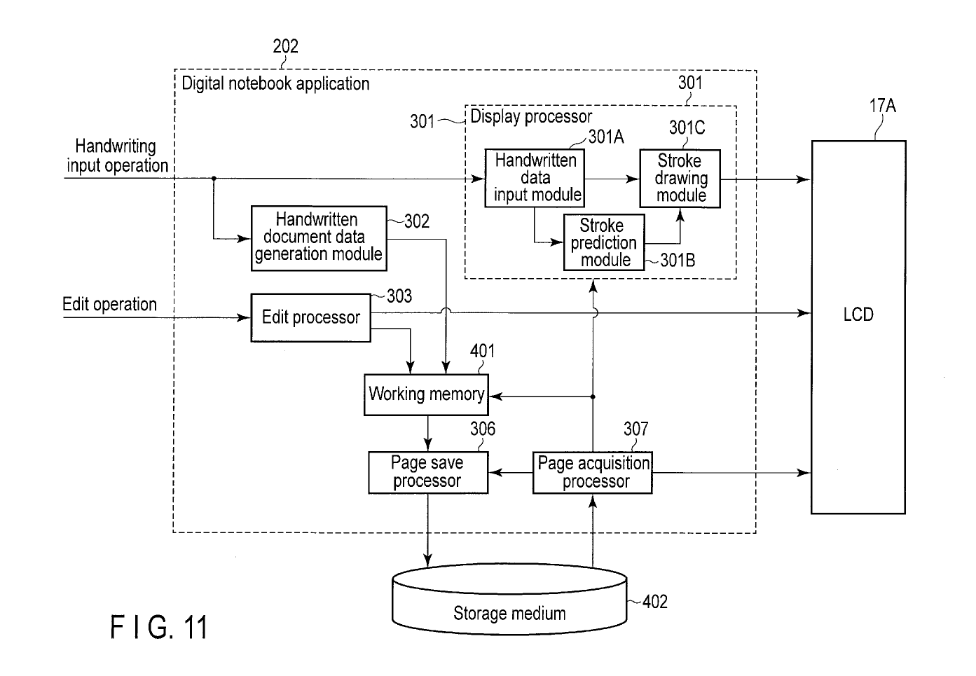

Now, a function configuration according to the digital notebook application program 202 will be explained with reference to FIG. 11.

The digital notebook application program 202 is a WYSIWYG application which allows use of handwritten document data. The digital notebook application program 202 includes, for example, a display processor 301, a handwritten document data generation module 302, an edit processor 303, a page save processor 306, a page acquisition processor 307 and a working memory 401. The display processor 301 includes a handwriting input module 301A, a stroke prediction module 301B and a stroke drawing module 301C.

The touch panel 17B is configured to detect the generation of an event such as an event “touch (contact)”, an event “move (slide)” or an event “release”. The touch (contact) event is an event indicating that an object (finger) contacts the screen. The move (slide) event is an event indicating that the contact position is moved while an object (finger) contacts the screen. The release event is an event indicating that an object (finger) is separated from the screen.

The digitizer 17C is also configured to detect the generation of an event such as an event “touch (contact)”, an event “move (slide)” or an event “release”. The touch (contact) event is an event indicating that an object (the stylus 100) contacts the screen. The move (slide) event is an event indicating that the contact position is moved while an object (the stylus 100) contacts the screen. The release event is an event indicating that an object (the stylus 100) is separated from the screen.

The digital notebook application program 202 displays a page edit screen for creating, viewing and editing the handwritten page data on the touch screen display 17.

The display processor 301 and the handwritten document data generation module 302 receive an event “touch (contact)”, “move (slide)” or “release” generated by the digitizer 17C and detect a handwriting input operation through the received event. The event “touch (contact)” includes the coordinates of the contact position. The event “move (slide)” includes a series of the coordinates of the contact positions which are moved. Thus, the display processor 301 and the handwritten document data generation module 302 are configured to receive a series of coordinates corresponding to the path of move of the contact position from the digitizer 17C.

The display processor 301 displays handwritten strokes on the screen in accordance with the movement of the object (the stylus 100) detected by the digitizer 17C on the screen. The display processor 301 displays, on the page edit screen, the path of the stylus 100 during a period of contact of the stylus 100 on the screen. In other words, the path of each stroke is displayed on the page edit screen.

The handwritten document data generation module 302 receives the series of coordinates output from the digitizer 17C and generates handwritten data including handwritten document data (a series of coordinate data items) having the structure explained in detail in FIG. 4 based on the series of coordinates. The handwritten document data generation module 302 temporarily stores the generated handwritten data in the working memory 401.

The edit processor 303 executes a process for editing the handwritten page which is currently displayed. The edit processor 303 executes an edit process including a process of adding a new stroke (a new handwritten character, a new handwritten mark, etc.) to the handwritten page which is currently displayed and a process of deleting or moving one or more strokes of the displayed strokes in accordance with an edit operation and a handwriting input operation performed by the user on the touch screen display 17. The edit processor 303 further updates the handwritten document data in the working memory 401 to reflect the result of the edit process in the handwritten document data which is displayed in progress.

The page save processor 306 stores, in a storage medium 402, handwritten page data including a plurality of stroke data items corresponding to a plurality of handwritten strokes on the handwritten page which is currently created. The storage medium 402 may be, for example, the storage device of the tablet computer 10 or may be the storage device of the server computer 2.

The page acquisition processor 307 obtains arbitrary handwritten page data from the storage medium 402. The obtained handwritten page data is supplied to the display processor 301. The display processor 301 displays a plurality of strokes corresponding to a plurality of stroke data items included in the handwritten page data on the screen.

The detail of the display processor 301 of FIG. 11 is explained.

As explained above, the touch screen display 17 detects a touch operation relative to the screen, using the touch panel 17B or the digitizer 17C. The handwritten data input module 301A is a module for inputting a detection signal output from the touch panel 17B or the digitizer 17C. The detection signal includes the coordinate data (X, Y) of the touch position. The detection signal input by the handwritten data input module 301A is supplied to the stroke prediction module 301B and the stroke drawing module 301C.

The stroke drawing module 301C is a module configured to draw the path (stroke) input in handwriting and display it on the LCD 17A of the touch screen display 17. The stroke drawing module 301C has a first drawing function for drawing a line segment corresponding to the path (stroke) input in handwriting based on the detection signal from the handwritten data input module 301A.

The stroke prediction module 301B predicts the position of a touch operation which will be detected after a predetermined time by the touch panel 17B or the digitizer 17C based on the detection signal from the handwritten data input module 301A. For example, the stroke prediction module 301B supplies the prediction result as a prediction signal to the stroke drawing module 301C with the same format as the detection signal from the handwritten data input module 301A. The stroke drawing module 301C has a second drawing function for drawing a line segment (prediction line segment) which is predicted to follow the line segment corresponding to the path (stroke) input in handwriting based on the prediction signal from the stroke prediction module 301B. In this manner, the stroke drawing module 301C displays, on the LCD 17A of the touch screen display 17, a line segment corresponding to the path (stroke) input in handwriting, and a line segment (prediction line segment) which is predicted to follow the line segment corresponding to the path (stroke) input in handwriting. A prediction line segment extends to a position which will be detected after a predetermined time. A touch operation is detected in a certain time cycle. Therefore, the length of the prediction line segment is determined by multiplying the detection pitch by the predetermined time. The tablet computer 10 has a mechanism configured to, for example, reduce the strangeness given to the user when the prediction is wrong. The detail of this mechanism is explained below.

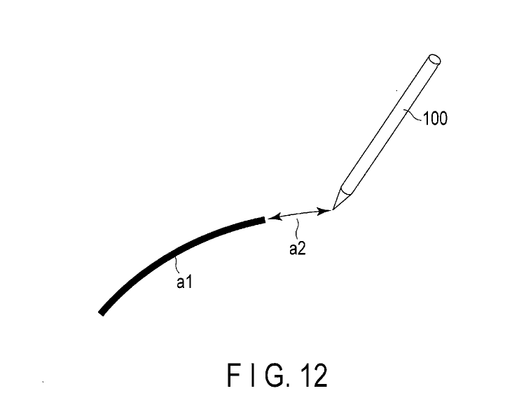

To facilitate understanding of the principle of a stroke display process executed by the tablet computer 10, first, the delay of drawing will be explained with reference to FIG. 12.

For example, when a character is written or a picture is drawn on the touch screen display 17 with the stylus 100, as stated above, the contact position of the stylus 100 on the screen is detected by the digitizer 17C. The digitizer 17C outputs a detection signal including the coordinate data indicating the contact position to the system controller 102. The system controller 102 stores the detection signal received from the digitizer 17C in the register of the system controller 102 and generates an interrupt signal for the CPU 101.

After the interrupt signal is generated, the detection signal is read from the register of the system controller 102 by the BIOS executed by the CPU 101 and is input to the digital notebook application program 202 operated under management of the OS 201. Based on the detection signal, the display processor 301 draws a line segment corresponding to the path (stroke) input in handwriting and displays the line segment on the LCD 17A of the touch screen display 17. The solid line segment a1 of FIG. 12 corresponds to the path (stroke) which is input in handwriting and which is displayed on the LCD 17A of the touch screen display 17.

However, the stylus 100 continues to move on the touch screen display 17 from when the contact position (the end point of line segment a1) of the stylus 100 on the screen is detected by the digitizer 17C to when line segment a1 corresponding to the path (stroke) input in handwriting is displayed on the LCD 17A of the touch screen display 17 through the above process. Thus, the line segment is drawn (displayed) behind the move of the position of the stylus 100. FIG. 12 shows drawing delay a2 caused in the above manner. To prevent the delay, the stroke delay may be predicted based on the past stroke, and further, a prediction stroke may be added to the end of the past stroke and be displayed. However, the prediction may be wrong sometimes. When the prediction is wrong, a uninteded stroke is displayed. This makes the user uncomfortable with the operation of the handwriting tablet.

In the present embodiment, measures are taken to reduce a feeling of strangeness of the user when the prediction is wrong. The prediction time or the stroke length is not fixed in accordance with the delay a2 shown in FIG. 12, and is variable in accordance with the handwriting situation. In general, the longer the prediction time or the stroke is, the shorter the delay time is and the response from the handwriting input to the display is good. However, there is a possibility that the prediction is wrong. When the prediction time or the stroke is short, delay is caused. Thus, the response is poor.

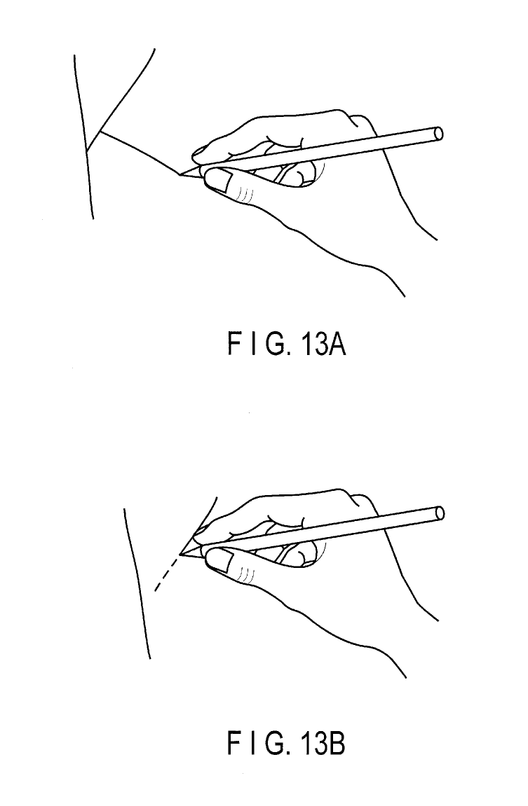

The degree of strangeness given to the user when the prediction is wrong varies depending on the move direction of the stylus, i.e. the writing direction and the dominant hand. For example, when the user is right handed, as shown in FIG. 13A or 13B, the hand is located on the right of the stylus. Because of this, a stroke extending to the right is hidden by the stylus or the hand. Thus, there is no problem even if a wrong prediction stroke is displayed if the stroke extends to the right. In addition, a stroke extending to the upper side may be hidden by the hand. Thus, display of a wrong prediction stroke does not cause the user to feel very uncomfortable with it if the stroke extends to the upper side. Even when, as shown in FIG. 13A, the prediction time or the prediction length is long, the wrong prediction of the third stroke of “K” (in other words, the stroke extending from the upper left to the lower right) does not stand out. When the prediction time or the prediction length is long, the user feels that the response is good as the change of displayed strokes keeps up with the move of the stylus point. However, as shown in FIG. 13B, the wrong prediction of the second stroke of “K” (in other words, the stroke extending from the upper right to the lower left) stands out. Thus, the prediction time or the prediction length is set so as to be short.

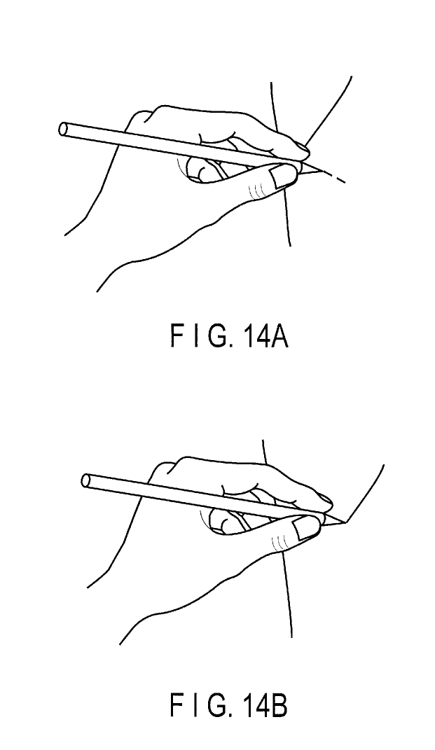

When the user is left handed, as shown in FIG. 14A or 14B, the hand is located on the left of the stylus. Since a stroke extending to the left is hidden by the stylus or the hand, there is no problem even if a wrong prediction stroke is displayed if the stroke extends to the left. In addition, a stroke extending to the upper side may be hidden by the hand. Thus, display of a wrong prediction stroke does not cause the user to feel very uncomfortable with it if the stroke extends to the upper side. Even when, as shown in FIG. 14B, the prediction time or the prediction length is long, the wrong prediction of the second stroke of “K” (in other words, the stroke extending from the upper right to the lower left) does not stand out. However, as shown in FIG. 14A, the wrong prediction of the third stroke of “K” (in other words, the stroke extending from the upper left to the lower right) stands out. Thus, the prediction time or the prediction length is set so as to be short.

In this manner, it is possible to realize the best response without causing the wrong prediction to stand out by changing the prediction time or the prediction length in accordance with the dominant hand and the move direction of the stylus.

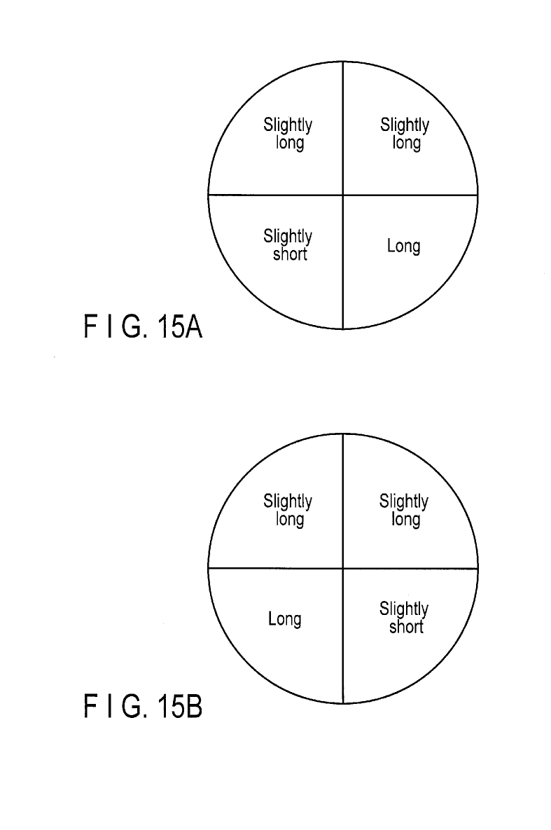

FIG. 15A or 15B shows an example of setting of the prediction time or the prediction length in terms of whether it should be long or short in accordance with the move direction of the stylus. FIG. 15A shows a case of a right-handed user. FIG. 15B shows a case of a left-handed user. In a case of a right-handed user, the lower right angle area (270 to 360 degrees) in the move direction of the stylus is set so as to be the longest; the upper right angle area (0 to 90 degrees) and the upper left angle area (90 to 180 degrees) are set so as to be slightly long; and the lower left angle area (180 to 270 degrees) is set so as to be slightly short. In a case of a left-handed user, the lower left angle area (180 to 270 degrees) is set so as to be the longest; the upper right angle area (0 to 90 degrees) and the upper left angle area (90 to 180 degrees) are set so as to be slightly long; and the lower right angle area (270 to 360 degrees) is set so as to be slightly short. In FIGS. 15A and 15B, the move angle range of the stylus is divided into four areas; however, the range may be divided into more than four areas.

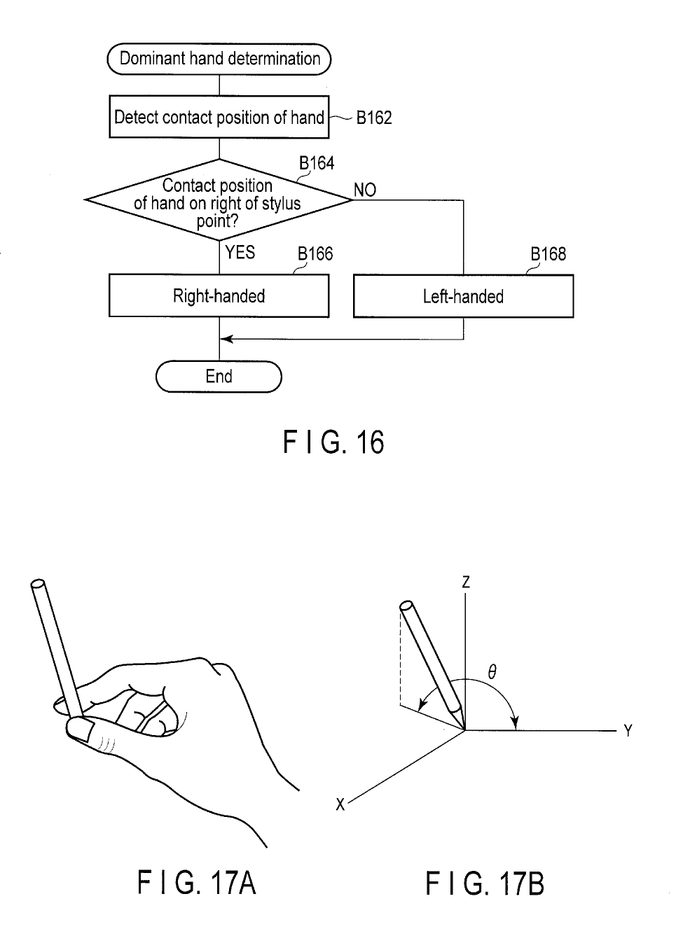

The dominant hand is set by the user on the setting screen shown in FIG. 8; however, the dominant hand may be automatically determined. The flow of this determination is shown in FIG. 16. At the time of a handwriting input operation in the stylus input mode, the contact position of the hand is also detected by the touch panel in block B162. In block B164, the position of the stylus point is detected by the digitizer, and further, the right-and-left relationship between the contact position of the hand and the position of the stylus point is determined. When the contact position of the hand is on the right of the position of the stylus point, the dominant hand is determined as a right hand in block B166. When the contact position of the hand is not on the right of the position of the stylus point, the dominant hand is determined as a left hand in block B168.

It is possible to determine whether the user is right handed or left handed based on whether or not the contact position of the hand is on the right of the stylus point at the time of a handwriting input operation in the stylus input mode.

The effect of the wrong prediction is generally determined based on the dominant hand and the move direction of the stylus. However, some people hold the stylus in a strange way. Therefore, the inclination of the stylus may be detected for reference. In general, as shown in FIGS. 13A, 13B, 14A and 14B, some people hold the stylus with inclination such that the stylus point is away from the user. However, some people hold the stylus such that the stylus is perpendicular to the screen of the touch screen display, or hold the stylus such that the stylus point is toward the user.

In consideration of the above factors, a three-axial acceleration sensor and a battery may be housed in the stylus 100. The prediction time or the length shown in FIGS. 15A and 15B may be adjusted in terms of whether it should be long or short in accordance with the angle θ (see FIG. 17B) inside the screen when the stylus is projected onto the screen (XY plane) of the touch screen display.

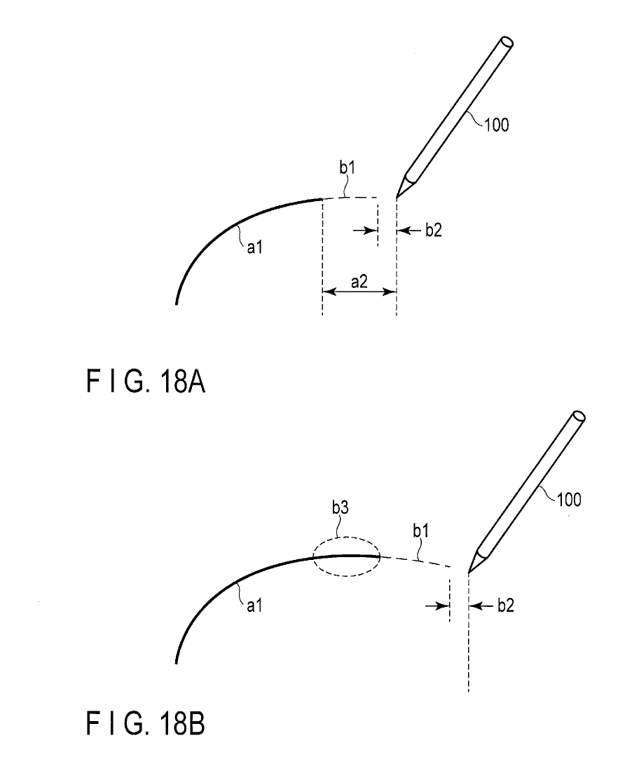

Next, a first example of a process for displaying a prediction stroke executed by the tablet computer 10 will be described with reference to FIGS. 18A and 18B.

As shown in FIG. 18A, the stroke drawing module 301C displays line segment b1 based on a prediction signal from the stroke prediction module 301B at time t1 such that line segment b1 is added to line segment a1 based on a detection signal from the handwritten data input module 301A. By the prediction of the stroke prediction module 301B, drawing delay a2 may be reduced to b2. The stroke prediction module 301B predicts a future stroke which will be made after a predetermined time. This predetermined time is changeable in accordance with the dominant hand and the move direction of the stylus, etc., as stated above and shown in FIG. 15A or 15B.

The tablet computer 10 updates the display in a certain cycle (for example, 1/60 seconds). As shown in FIG. 18B, at time t1+Δt, line segment b3 corresponding to the actual stroke is displayed instead of prediction line segment b1 of time t1. Thus, the line segment corresponding to the actual stroke extends for each Δt. The line segment viewable for the user in a time point is controlled so as to be always a line segment created by adding a prediction line segment to the actual line segment based on a detection signal. In other words, the prediction line segment is displayed in only the display update cycle Δt.

More specifically, line segment a1 based on a detection signal is carried over to the next time and develops in accordance with the detection signal of the next time. However, prediction line segment b1 written at time t1 is not carried over to the next time t1+Δt. As indicated by symbol b3, prediction line segment b1 of time t1 is not drawn at the next time t1+Δt. Instead, line segment a1 based on a detection signal is drawn. Prediction line segment b1 is drawn such that it is newly added to line segment a1 based on the detection signal. When strokes are drawn in this manner, and the prediction is right (in other words, prediction line segment b1 at time t1 substantially conforms to line segment b3 which is the extension at time t1+Δt), the user feels as if the line is extending continuously.

Even when the prediction is wrong, prediction line segment b1 at time t1 which is very different from the actual line is deleted at the next time t1+Δt. Instead, line segment b3 based on a detection signal is displayed. Thus, the user merely sees flicker at a moment. The wrong prediction line segment does not stand out very much. The length of prediction line segment b1 to be displayed differs depending on the move direction of the stylus and the dominant hand. When display of a wrong prediction stroke does not cause a problem, the length is set so as to be long to improve the response. When the wrong prediction stands out, the length is set so as to be short to prevent the user from feeling uncomfortable with the wrong prediction.

Thus, the tablet computer 10 which displays prediction line segment b1 whose length is based on the move direction of the stylus and the dominant hand in only a predetermined period is configured to reduce the strangeness given to the user when the prediction is wrong.

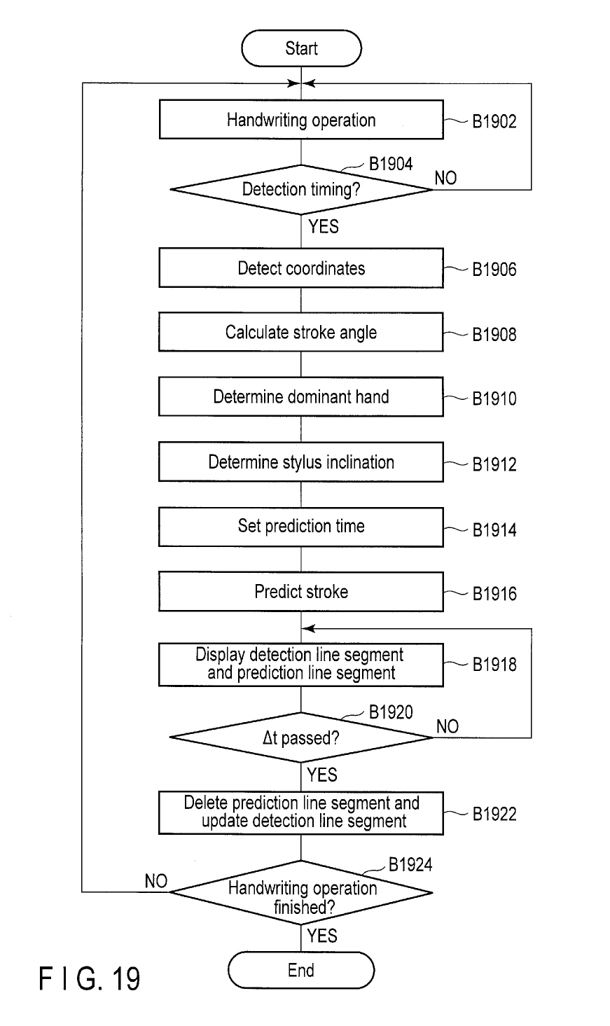

FIG. 19 is an exemplary flowchart showing the flow of a process of the display processor 301 configured to perform the display shown in FIGS. 18A and 18B. In block B1902, a handwriting operation is performed. A character, a symbol, a drawing or a table is handwritten with the stylus 100 on the touch screen display 17. The handwriting input module 301A samples the path (coordinates) of the stylus 100 in a predetermined cycle (block B1904 and block B1906). When the coordinates of the stylus 100 are detected, handwritten document data is obtained as shown in FIG. 4. The stroke prediction module 301B obtains the move direction of the stylus, i.e. the writing direction of the current stroke, using the coordinate data of a point immediately before or some points before the current point in block B1908. The stroke prediction module 301B determines the dominant hand in block B1910. The dominant hand may be determined based on the setting data shown in FIG. 8 or may be determined based on the flowchart shown in FIG. 16. In block B1912, the stroke prediction module 301B also determines the inclination of the stylus. Block B1912 may be omitted. In block B1914, the stroke prediction module 301B determines the prediction time based on the dominant hand and the writing direction as shown in FIGS. 15A and 15B, and in addition, the inclination of the stylus sometimes. In block B1916, the stroke prediction module 301B predicts the stroke which will be made after the prediction time. In block B1918, the stroke drawing module 301C displays a stroke created by connecting a prediction line segment which corresponds to the stroke predicted by the stroke prediction module 301B to a detection line segment which corresponds to the actual stroke and is calculated based on the sample coordinates input from the handwritten data input module 301A.

In block B1920, it is determined whether or not a certain time Δt has passed. Before the elapse of the certain time Δt, the process returns to block B1918. After the elapse of the certain time Δt, the display of the prediction line segment is deleted, and further, the detection line segment is updated in block B1922.

In block B1924, it is determined whether or not the handwriting operation is in progress. When the operation is in progress, the process returns to block B1902. When the operation is not in progress, the process ends.

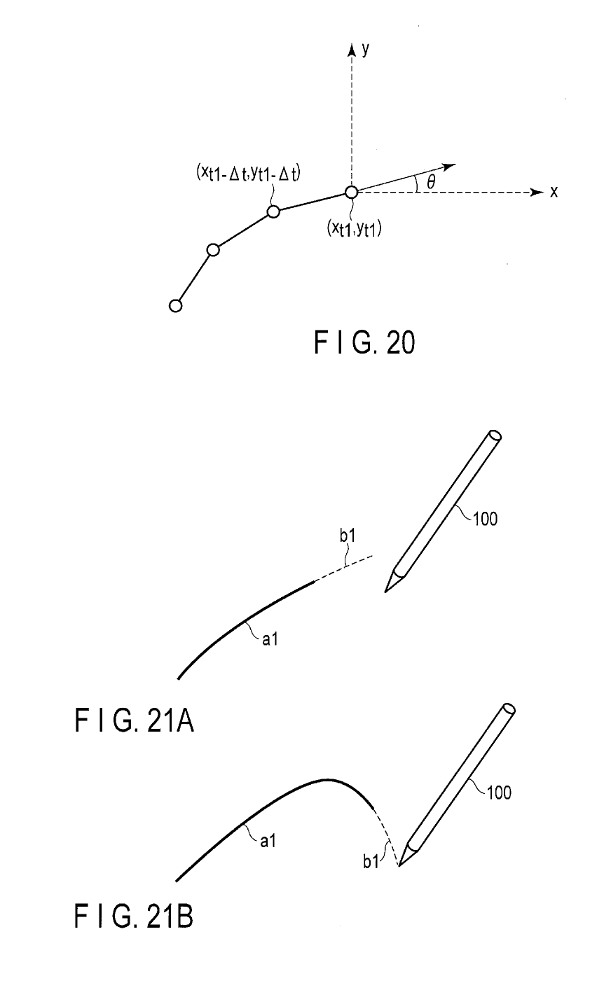

Now, an example of the way of calculating the writing direction, i.e. the moving direction of the stylus in block B1908 will be described with reference to FIG. 20.

FIG. 20 shows the coordinates of the sample points of the stylus point, and the stroke connecting the sample points. The values m and n are integers and shown by the following expression: m>n>0.

The difference vector Vₜ₋ₙ between the coordinates (Xₜ, Yₜ) which is currently sampled and the coordinates (Xₜ₋ₙ, Yₜ₋ₙ) which is the closest to the coordinates (Xₜ, Yₜ) is calculated.

Vₜ₋ₙ=(Xₜ−Xₜ₋ₙ,Yₜ−Yₜ₋ₙ)

The angle θ of this vector is calculated.

θ=arctan(Vₜ₋ₙ)

Here, arctan (V) returns the inclination from the original point with a radian angle (−π to π). This is the writing direction angle θ.

In the above explanation, a prediction line segment whose length is based on the writing direction and the dominant hand is displayed in a certain period (for example, 1/60 seconds). However, when the update cycle of the display is changeable (for example, 1/240 seconds, 2/240 (= 1/120) seconds, 3/240 (= 1/80) seconds or 4/240 (= 1/60) seconds), the same effect can be obtained by setting the length of the prediction line segment so as to be constant but setting the display time in accordance with the writing direction and the dominant hand. When the wrong prediction is expected to stand out, the display time of the prediction line segment may be set so as to be short. When the wrong prediction is not expected to stand out, the display time of the prediction line segment may be set so as to be long.

Now, a second example of a process for displaying a stroke executed by the tablet computer 10 will be described.

In the first example, it is not assumed that a detection line segment corresponding to the actual stroke is displayed in a form different from that of a variable-length prediction line segment corresponding to a prediction stroke. In other words, both are displayed in the same color, luminance and thickness. In the second example, the color, luminance, thickness and the like of a prediction line segment are changeable for display in association with the length of the prediction line segment.

FIGS. 21A and 21B show the second example of a process for displaying a prediction stroke. The stroke drawing module 301C changes the color of prediction line segment b1 displayed in only a predetermined period with a length based on the writing direction of the stroke so as to be light in accordance with the length in comparison with line segment a1 based on a detection signal. For example, when the color data is structured by a set of R (red), G (green) and B (blue), and R, G and B are set to the same value, a black color can be shown. When the color data is either set to, for example, (0, 0, 0) or (50, 50, 50), a black color is shown. However, the latter case shows lighter black than the former case. The color of prediction line segment b1 is made light by the above color data setting.

Thus, the color of the variable-length prediction line segment b1 displayed in only a predetermined period is made light in accordance with the length of the line segment (the longer the line segment is, the darker it is made; and the shorter the line segment is, the lighter it is made) in comparison with line segment a1 based on a detection signal. In this manner, even if the prediction is wrong, the wrong prediction can be made less noticeable.

In the above description, change in the shading of color is explained. However, the luminance or the thickness may be changeable for display in accordance with the length of the line segment. The longer the line segment is, the higher the luminance is made; and the shorter the line segment is, the lower the luminance is made. The longer the line segment is, the thicker it is made; and the shorter the line segment is, the thinner it is made. These settings may be combined. A prediction stroke may be displayed so as to stand out in a direction in which the stroke is hidden by the hand, and displayed so as not to stand out in a direction in which the stroke is not hidden by the hand in comparison with the former case.

The second example can be further modified as follows. In the above explanation, a prediction line segment is displayed in only a certain period which is an update cycle of display. However, a prediction line segment may be displayed over several update cycles. The color, luminance, thickness and the like of the prediction line segment may be changeable in accordance with the length of the prediction line segment as the time passes.

As explained above, according to the embodiment, in consideration of the dominant hand of the user and the writing direction, the prediction time (or the length of the prediction line segment to be displayed) can be changed for a case where the portion which will be written is hidden by the hand and the other case. In this manner, it is possible to display a handwritten stroke which is difficult to be noticed by the user even if the prediction is wrong. When the portion which will be written is hidden by the hand, a long prediction line segment is displayed. In this way, the user can feel that the display follows the move of the stylus point. In this case, even if the prediction is wrong, the prediction line segment is not entirely displayed. Thus, the user is less affected by the wrong prediction. Further, the prediction time can be changed in accordance with the writing direction or the moving direction of the stylus. In this manner, the effect can be further enhanced.

The processes of the embodiments described herein may be realized by a computer program. Thus, the same effect as that of the embodiments can be easily obtained by merely installing the computer program in a computer through a computer-readable storage medium in which the computer program is stored and executing the program.

The present invention is not limited to the above embodiments as they are. The structural elements may be modified for implementation without departing from the spirit of the invention. Various inventions may be formed by appropriately combining the structural elements disclosed in the above embodiments. For example, some of the structural elements disclosed in the embodiments may be deleted. Further, structural elements may be appropriately combined over different embodiments.

What is claimed is:

1. A method comprising:
receiving stroke data corresponding to a first stroke handwritten on a display; and
displaying, on the display, the first stroke corresponding to the stroke data and a second stroke following the first stroke, the second stroke comprising a variable length depending on a handwriting direction of the first stroke.

2. The method of claim 1, wherein
the variable length depends on whether the first stroke is handwritten by a right hand or a left hand.

3. The method of claim 1, wherein
the variable length is longer when the first stroke is handwritten in a direction approaching a hand than when the first stroke is handwritten in a direction away from the hand.

4. The method of claim 1, wherein
the variable length is longer when the first stroke is handwritten in a right direction by a right hand than when the first stroke is handwritten in a left direction by a right hand, and
the variable length is shorter when the first stroke is handwritten in a left direction by a left hand than when the first stroke is handwritten in a right direction by a left hand.

5. The method of claim 4, wherein
the variable length is longer when the first stroke is handwritten in a lower right direction by a right hand than when the first stroke is handwritten in a lower left direction by a right hand, and
the variable length is longer when the first stroke is handwritten in a lower left direction by a left hand than when the first stroke is handwritten in a lower right direction by a right hand.

6. The method of claim 5, wherein
in handwriting with a right hand,
the variable length is the longest when the first stroke is handwritten in a lower right direction,
the variable length is the second longest when the first stroke is handwritten in an upper right direction or an upper left direction, and
the variable length is the shortest when the first stroke is handwritten in a lower left direction, and
in handwriting with a left hand,
the variable length is the longest when the first stroke is handwritten in a lower left direction,
the variable length is the second longest when the first stroke is handwritten in an upper right direction or an upper left direction, and
the variable length is the shortest when the first stroke is handwritten in a lower right direction.

7. The method of claim 1, wherein
the displaying comprises displaying the first stroke corresponding to the stroke data and a prediction stroke corresponding to the stroke data.

8. The method of claim 7, comprising:
displaying the prediction stroke for a predetermined period.

9. An electronic device comprising:
circuitry configured to
receive stroke data corresponding to a first stroke handwritten on a display and
displaying, on the display, the first stroke corresponding to the stroke data and a second stroke following the first stroke, the second stroke comprising a variable length depending on a handwriting direction of the first stroke.

10. The electronic device of claim 9, wherein
the variable length depends on whether the first stroke is handwritten by a right hand or a left hand.

11. The electronic device of claim 9, wherein
the variable length is longer when the first stroke is handwritten in a direction approaching a hand than when the first stroke is handwritten in a direction away from the hand.

12. The electronic device of claim 1, wherein
the variable length is longer when the first stroke is handwritten in a right direction by a right hand than when the first stroke is handwritten in a left direction by a right hand, and
the variable length is shorter when the first stroke is handwritten in a left direction by a left hand than when the first stroke is handwritten in a right direction by a left hand.

13. The electronic device of claim 1, wherein
the circuitry is configured to display the first stroke corresponding to the stroke data and a prediction stroke corresponding to the stroke data.

14. A non-transitory computer-readable storage medium storing a computer program which is executable by a computer, the computer program controlling the computer to execute functions of:
receiving stroke data corresponding to a first stroke handwritten on a display; and
displaying, on the display, the first stroke corresponding to the stroke data and a second stroke following the first stroke, the second stroke comprising a variable length depending on a handwriting direction of the first stroke.

15. The storage medium method of claim 14, wherein
the variable length depends on whether the first stroke is handwritten by a right hand or a left hand.

16. The storage medium method of claim 14, wherein
the variable length is longer when the first stroke is handwritten in a direction approaching a hand than when the first stroke is handwritten in a direction away from the hand.

17. The storage medium method of claim 14, wherein
the variable length is longer when the first stroke is handwritten in a right direction by a right hand than when the first stroke is handwritten in a left direction by a right hand, and
the variable length is shorter when the first stroke is handwritten in a left direction by a left hand than when the first stroke is handwritten in a right direction by a left hand.

18. The storage medium method of claim 14, wherein
the displaying comprises displaying the first stroke corresponding to the stroke data and a prediction stroke corresponding to the stroke data.
